(19) United States
(12) Patent Application Publication
(10) Pub. No.: US 2023/0385978 A1
(43) Pub. Date: Nov. 30, 2023

(54) DRIVER SUPPLY CONTROL

(71) Applicant: Lyft, Inc., San Francisco, CA (US)

(72) Inventors: Kevin Fan, San Francisco, CA (US); Ben Lauzier, San Francisco, CA (US)

(21) Appl. No.: 18/446,273

(22) Filed: Aug. 8, 2023

Related U.S. Application Data
(63) Continuation of application No. 14/977,353, filed on Dec. 21, 2015, now abandoned.

(51) Int. Cl. G06Q 50/30; G06Q 50/00; G06Q 10/0631; G06Q 30/0208

(52) U.S. Cl. CPC G06Q 50/30; G06Q 50/01; G06Q 10/06315; G06Q 30/0208

(57) ABSTRACT

A system for supply control includes an input interface and a processor. The input interface is to receive an indication of an expected event. The processor is to determine a historic event similar to the expected event, determine an expected driver demand for the expected event based at least in part on the similar historic event, and determine one or more incentives to meet the expected driver demand.

### CROSS-REFERENCE TO RELATED APPLICATIONS

This application is a continuation of U.S. patent application Ser. No. 14/977,353, filed on Dec. 21, 2015. The aforementioned application is hereby incorporated by reference in its entirety.

### BACKGROUND OF THE INVENTION

A ride sharing system connects drivers who wish to share their vehicles with riders looking for a ride. When drivers are efficiently matched with riders, the system can largely self-regulate the driver supply. For instance, a driver will typically learn what times it is profitable to give rides (e.g., what times rides are in demand) and what times it is not profitable to give rider (e.g., what times rides are not in demand). However, demand for rides additionally changes as a result of unusual events (e.g., events that are not part of a typical daily or weekly schedule) and the self-regulating mechanism is inadequate for handling unusual events.

### BRIEF DESCRIPTION OF THE DRAWINGS

Various embodiments of the invention are disclosed in the following detailed description and the accompanying drawings.

FIG. 1 is a block diagram illustrating an embodiment of a network system.

FIG. 2 is a block diagram illustrating an embodiment of a driver dispatch server system.

FIG. 3 is a block diagram illustrating an embodiment of an incentive system.

FIG. 4A is a diagram illustrating an embodiment of a typical demand and an event demand.

FIG. 4B is a diagram illustrating an embodiment of a typical demand and an event demand.

FIG. 5 is a diagram illustrating an embodiment of city regions.

FIG. 6 is a diagram illustrating an embodiment of a user device display for a default display for a driver system.

FIG. 7 is a diagram illustrating an embodiment of a user device display for an incentive indication.

FIG. 8 is a diagram illustrating an embodiment of a user device display for an incentive indication.

FIG. 9 is a flow diagram illustrating an embodiment of a process for driver supply control.

FIG. 10 is a flow diagram illustrating an embodiment of a process for determining a historic event similar to the expected event.

FIG. 11 is a flow diagram illustrating an embodiment of a process for determining an expected driver demand for the expected event based at least in part on the historic event.

FIG. 12 is a flow diagram illustrating an embodiment for a process for determining one or more incentives to meet expected demand.

FIG. 13 is a flow diagram illustrating an embodiment of a process for notifying drivers of the one or more incentives.

FIG. 14 is a flow diagram illustrating an embodiment of a process for determining event results.

FIG. 15 is a flow diagram illustrating an embodiment of a process for driver supply control.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Driver supply control is disclosed. In some embodiments, a system for driver supply control comprises an input interface to receive an indication of an expected event, and a processor to determine a historic event similar to the expected event, determine an expected driver demand for the expected event based at least in part on the similar historic event, and determine one or more incentives to meet the expected driver demand. In some embodiments, the system comprises a processor and a memory, wherein the memory is coupled to the processor and configured to provide the processor with instructions.

In some embodiments, a system for driver supply control comprises a system for providing driver incentives based at least in part on a historical model of an expected event. The system for driver supply control comprises part of a system for ride sharing (e.g., a system for connecting drivers and riders). In some embodiments, the driver supply adapts automatically to demand (e.g., it is more profitable for drivers to drive when demand is higher, so more drivers will decide to drive). In some embodiments, driver supply does not self-adapt to expected events (e.g., driver supply does not materialize even though it is known that an expected event is known to be coming up). In some embodiments, an expected event comprises an event affecting driver demand that is anomalous (e.g., irregular, out of the ordinary) but still can be predicted as to taking place in the future (e.g., a rainstorm, a sporting event, a festival, etc.). The system for driver supply control comprises a system for affecting a driver supply in response to an expected event.

In some embodiments, the system for driver supply control receives an indication of the expected event and determines one or more historical events in response. The one or more historical events comprise events that are similar in one or more respects (e.g., event type, event size, event location, event time, etc.) to the expected event. Data (e.g., the driver demand) from the one or more historical events is used to determine an expected driver demand. One or more incentives are then determined in order to encourage drivers to drive (e.g., based on a model of increased drivers as a function of incentives). In some embodiments, incentives are provided in order to encourage drivers to move from a low demand region to a high demand region. In various embodiments, driver incentives comprise an increased driver rate, a guaranteed driver minimum pay per hour, a guaranteed number of rides per hour, or any other appropriate driver incentive. A historical driver yield is determined (e.g., what fraction of drivers provided with an incentive historically join the driver pool as a result?) and used to determine the number of drivers to whom an incentive should be provided. The appropriate number of drivers are then provided with the incentive. The system for ride sharing then provides rides during the event and determines event data. Demand for the event is determined and used to create a historical model of the event, which is added to the collection of historical models for events for use in future prediction. Driver yield from the incentive is determined and used to update historical models of driver yield.

In some embodiments, a system for supply control comprises an input interface and a processor. The input interface is to receive a metric associated with driver demand. The processor is to determine a driver demand based on the metric and determine one or more incentives to meet the driver demand. For example, a measure of driver demand is received (e.g., an ETA of a driver to pick up a ride sharer). In the case where the received estimated time of arrival (ETA) is greater than a threshold value. The system determines how many addition drivers are desired (e.g., using a model of an ideal number, percentage, etc. of the current number of drivers.

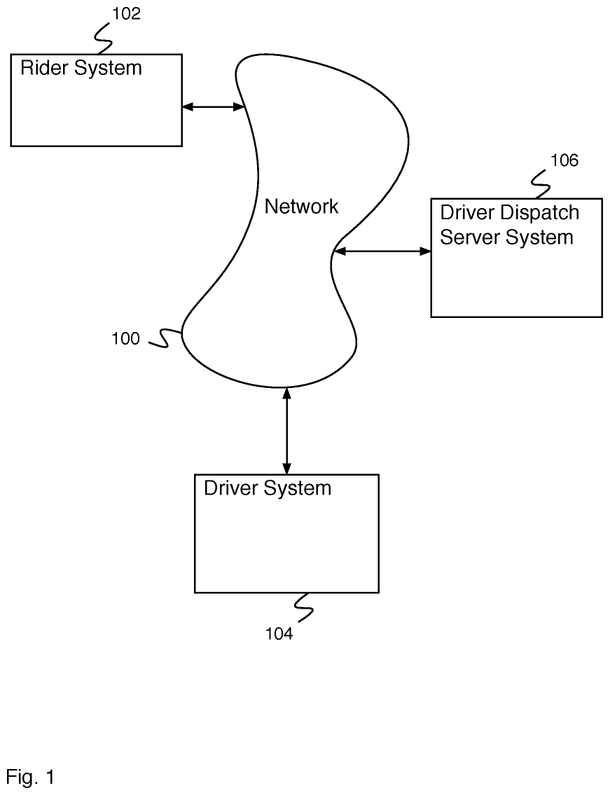

FIG. 1 is a block diagram illustrating an embodiment of a network system. In the example shown, FIG. 1 comprises network 100. In various embodiments, network 100 comprises one or more of the following: a local area network, a wide area network, a wired network, a wireless network, the Internet, an intranet, a storage area network, a cellular network, or any other appropriate communication network. Rider system 102 or driver system 104 comprise user systems (e.g., computing systems for operation by users). In some embodiments, rider system 102 or driver system 104 comprise systems accessed by a user directly (e.g., the user is in proximity with the user system). In some embodiments, rider system 102 or driver system 104 comprise systems accessed by a user remotely (e.g., the user is not in proximity with rider system 102 or driver system 104 and accesses rider system 102 or driver system 104 via network 100). In the example shown, rider system 102 or driver system 104 comprise mobile devices (e.g., smartphones, tablet computers, etc.). Rider system 102 or driver system 104 comprise a system that accesses driver dispatch server system 106 (e.g., accessing driver dispatch server system 106 via network 100). In various embodiments, there are 2, 5, 22, 122, 4320, 26100, or any other appropriate number of user systems (e.g., rider systems and/or driver systems) accessing driver dispatch server system 106. Driver dispatch server system 106 comprises a system for managing drivers giving rides to riders. In some embodiments, driver dispatch server system 106 comprises a system for connecting a rider and a driver. In some embodiments, driver dispatch server system 106 comprises a system for determining a driver to assign a ride to. In some embodiments, driver dispatch server system 106 comprises a system for assigning multiple rides to a driver. In some embodiments, driver dispatch server system 106 comprises a system for driver screening. In various embodiments, driver dispatch server system 106 comprises a computer, a computer with multiple processors, multiple computers connected via a local network, multiple computers connected via a wide area network, multiple computers connected via the Internet, multiple computers connected via network 100, or any other appropriate computing system or systems. In various embodiments, the processors comprising rider system 102, driver system 104, and driver dispatch server system 106 comprise any one of a variety of proprietary or commercially available single or multi-processor systems (e.g., an Intel™-based processor) or other type of commercially available processor able to support communications in accordance with each particular embodiment and application.

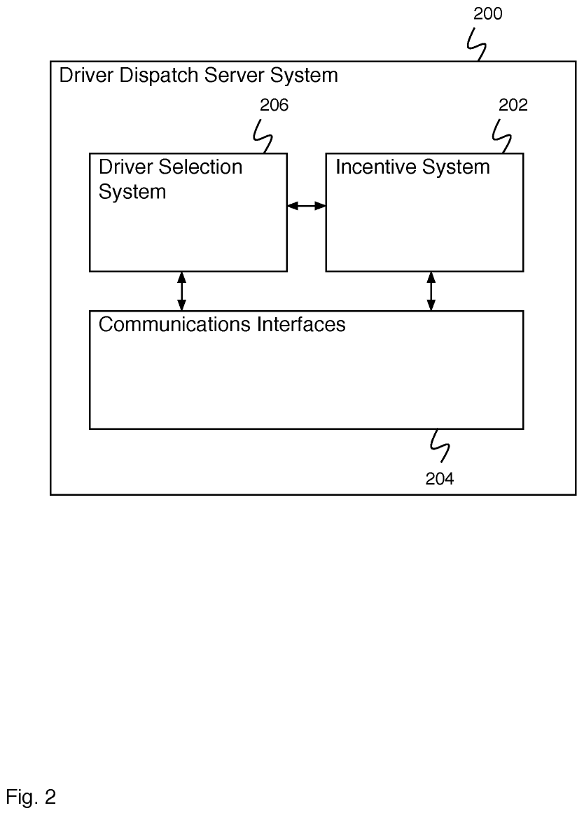

FIG. 2 is a block diagram illustrating an embodiment of a driver dispatch server system. In some embodiments, driver dispatch server system 200 comprises driver dispatch server system 106 of FIG. 1. In the example shown, driver dispatch server system 200 comprises communications interfaces 204. In some embodiments, communications interfaces 204 comprises an input interface for receiving information via a network (e.g., from a rider system or a driver system). In various embodiments, an input interface comprises an input interface for receiving a request for a pickup including a first pickup location and a first destination, for receiving a first pickup arrival indication indicating a driver arrived at the first pickup location, receiving a request for a second pickup including a second pickup location and a second destination, or for receiving any other appropriate information. In some embodiments, communications interfaces 204 comprises an output interface for providing information via a network (e.g., to a rider system or a driver system). In various embodiments, an output interface comprises an output interface for providing a first pickup indication to a driver to go to a first pickup location, for providing a first destination indication indicating to the driver to go to the first destination, or for providing any other appropriate information. In some embodiments, communications interfaces 204 is implemented using a processor. Driver selection system 206 comprises a driver selection system for selecting a driver. In some embodiments, driver selection system 206 selects a driver to assign to a ride based on a ride criteria. In some embodiments, driver selection system receives a ride request (e.g., via communications interfaces 204) and determines a driver to assign the ride. In various embodiments, driver selection system 206 determines a driver based at least in part on a detour criterion, a pickup delay criterion, a distance criterion, or any other appropriate criteria. In some embodiments, driver selection system 206 is implemented using a processor. Incentive system 202 comprises a system for providing incentives to drivers. In some embodiments, incentives are provided to drivers in advance of expected events (e.g., to encourage drivers to drive during expected times of higher demand). In some embodiments, incentives are provided to drivers in response to unexpected high demand. In some embodiments, incentive system 202 determines events based at least in part on historical data of events. In some embodiments, incentive system 202 is implemented using a processor. In various embodiments, the elements of driver dispatch server system 200 are implemented all on a single processor, each on an individual processor, or shared among multiple processors in any appropriate way.

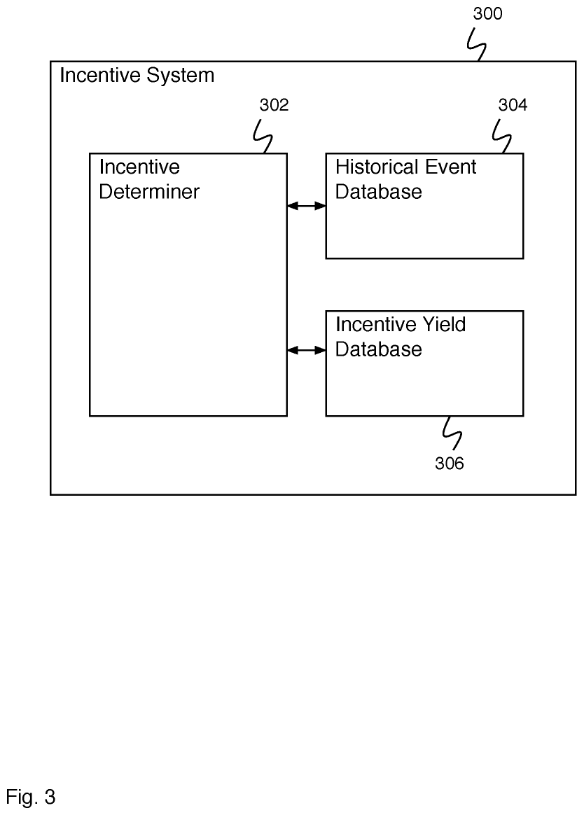

FIG. 3 is a block diagram illustrating an embodiment of an incentive system. In some embodiments, incentive system 300 implements incentive system 202 of FIG. 2. In the example shown, incentive determiner 302 comprises an incentive determiner for determining one or more incentives. In some embodiments, incentives comprise incentives encouraging drivers to drive. In various embodiments, incentives comprise an increased rate, an hourly minimum rate, an hourly minimum number of rides, or any other appropriate incentives. In various embodiments, incentives comprise incentive timing (e.g., when is the incentive active), incentive scale (e.g., how large is the rate increase), an incentive number of drivers, an incentive driver type (e.g., only send the incentive to highly rated drivers), an incentive region (e.g., a geographic region where the incentive is in effect), or any other appropriate incentive information. Historical event database 304 comprises a historical event database for storing data describing historical events. In some embodiments, historical events comprise historical events affecting driver demand. In various embodiments, historical event data comprises event type, event location, event time, driver demand (e.g., as a function of time and location), or any other appropriate historical event data. In some embodiments, incentive determiner 302 determines incentives based at least in part on historical data from historical event database 304. Incentive yield database 306 comprises an incentive yield database for storing data describing incentive yield. In some embodiments, incentive yield comprises a fraction of drivers provided with an incentive that decide to driver as a result. In some embodiments, incentive determiner 302 determines incentives based at least in part on data from incentive yield database 306. In some embodiments, incentive determiner 302 uses data from incentive yield database 306 to determine a number of drivers to provide with incentives (e.g., using a model).

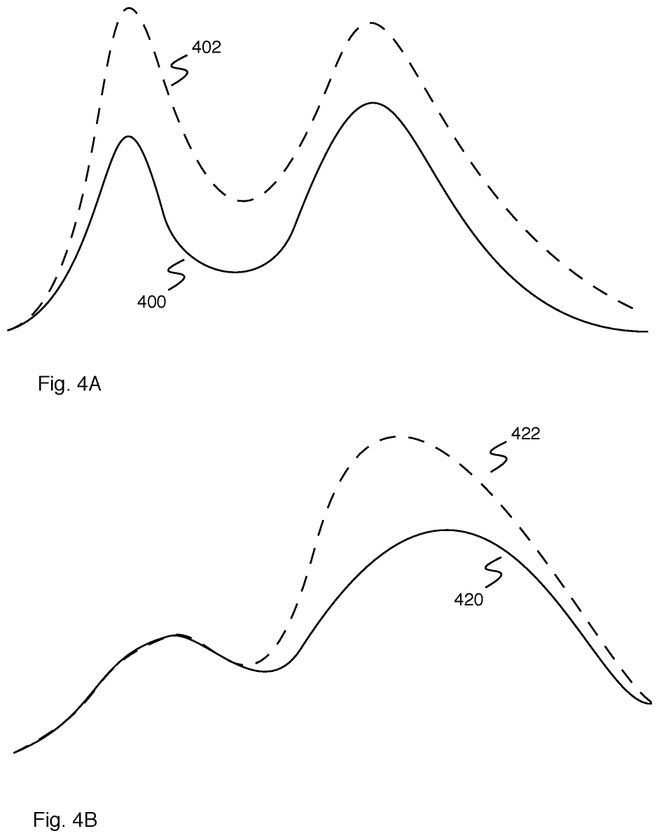

FIG. 4A is a diagram illustrating an embodiment of a typical demand and an event demand. In some embodiments, the demand of FIG. 4A comprises driver demand (e.g., a number of requests for drivers) to a ride sharing service including a driver dispatch system. In the example shown, typical demand 400 comprises a typical demand for a Monday (e.g., the expected driver demand for a typical Monday). Event demand 402 comprises an expected demand in the conditions of a Monday morning rainstorm. In the example shown, demand is higher than typical demand consistently through the day, reaching particular highs during the morning and evening rush. In some embodiments, event demand 402 comprises demand from previous events (e.g., previous Monday morning rainstorms). In some embodiments, event demand 402 comprises demand from a particular previous event (e.g., measured demand during a previous rainstorm). In some embodiments, event demand 402 comprises a composite demand (e.g., a combined demand of several events).

FIG. 4B is a diagram illustrating an embodiment of a typical demand and an event demand. In some embodiments, the demand of FIG. 4B comprises driver demand (e.g., a number of requests for drivers) to a ride sharing service including a driver dispatch system. In the example shown, typical demand 420 comprises a typical demand for a Saturday. Event demand 422 comprises an expected demand for a Saturday with an evening baseball game. In the example shown, demand begins picking up above the typical demand in the early afternoon and reaches a peak high above the typical peak. The slope of the rise in demand is sharp and the falloff in demand is slow. In some embodiments, event demand 422 comprises an event demand for a region near a baseball stadium (e.g., the expected increase in demand is only for the region near the baseball stadium).

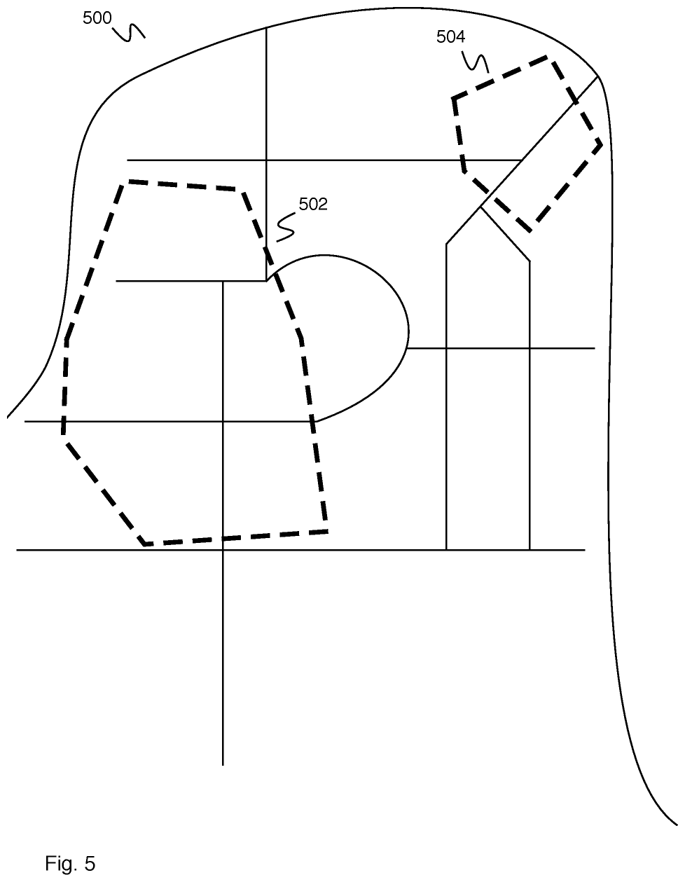

FIG. 5 is a diagram illustrating an embodiment of city regions. In some embodiments, the city regions of FIG. 5 comprise city regions affected by an expected event. In some embodiments, the city regions of FIG. 5 comprise city regions affecting a driver incentive. In the example shown, quiet region 502 and downtown region 504 comprise regions of city 500. In some embodiments, an incentive only applies to a downtown region (e.g., downtown region 504). In various embodiments, an incentive applies to rides entering a downtown region, rides leaving a downtown region, rides entering or leaving a downtown region, or any other appropriate rides. In some embodiments, an incentive is provided to encourage drivers to leave a quiet region (e.g., quiet region 502). In some embodiments, an incentive is sent to all drivers within quiet region 502. In some embodiments, the incentive is sent to a fraction of drivers within quiet region 502 (e.g., highly rated drivers within quiet region 502). In some embodiments, the incentive applies in the event the driver leaves quiet region 502. In some embodiments, the incentive applies in the event the driver leaves quiet region 502 and drives to downtown region 504.

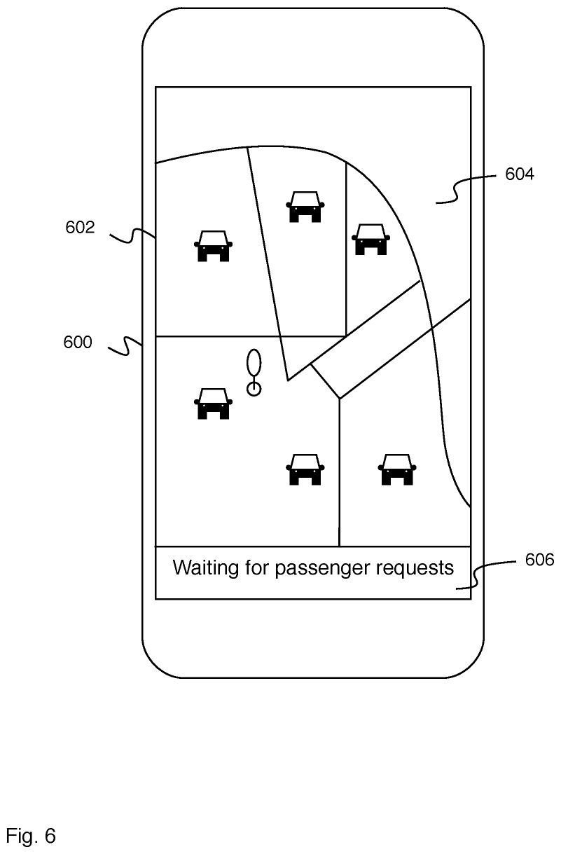

FIG. 6 is a diagram illustrating an embodiment of a user device display for a default display for a driver system. In some embodiments, the diagram of FIG. 6 illustrates the display of driver system 104 of FIG. 1. In the example shown, driver system 600 comprises display 602. Display 602 comprises a default display for a driver system. Display 602 comprises map 604, displaying the local area around the driver system. Map 604 comprises local roads and geographical features, car icons indicating other active driver systems and a pin icon indicating the driver system position. Display 602 additionally comprises waiting for passenger requests display 606, indicating the driver system is waiting for passenger requests.

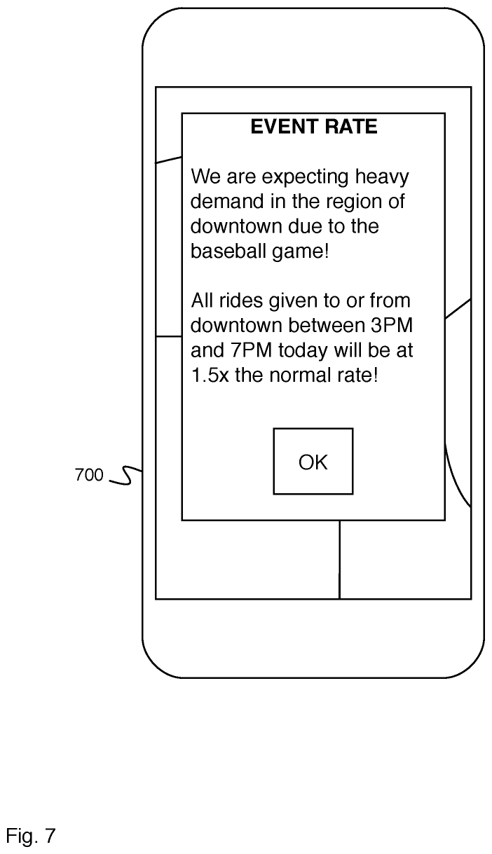

FIG. 7 is a diagram illustrating an embodiment of a user device display for an incentive indication. In some embodiments, driver system 700 of FIG. 7 comprises driver system 600 of FIG. 6 in the event an incentive is received. In the example shown, the incentive comprises a driver location incentive (e.g., an offer to pay at a higher rate (e.g., 1.5x the normal rate) a driver to move to a location of expected high demand). In the example shown, the incentive does not require a response (e.g., a driver does not need to opt in or opt out of the incentive). In some embodiments, the incentive applies to all drivers. In some embodiments, the incentive only applies to a subset of drivers (e.g., the incentive indication is not provided to all drivers).

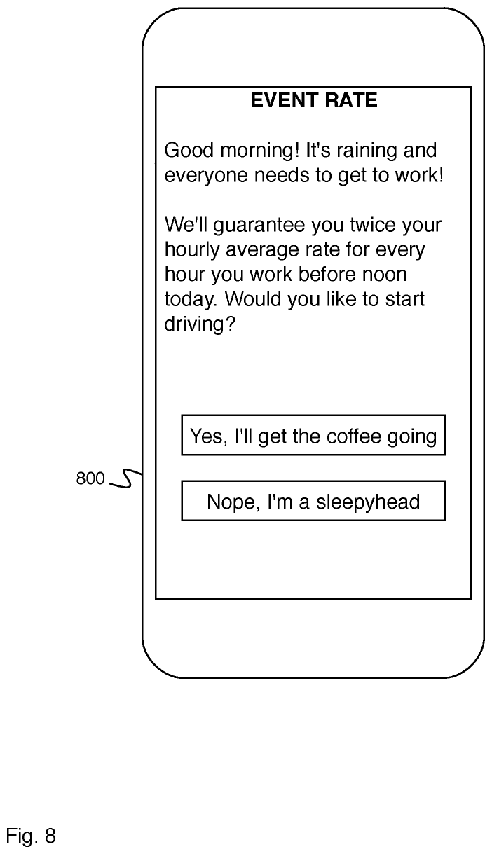

FIG. 8 is a diagram illustrating an embodiment of a user device display for an incentive indication. In some embodiments, driver system 700 of FIG. 7 comprises driver system 600 of FIG. 6 in the event an incentive is received. In the example shown, the incentive is provided to a set of drivers that are not driving. The incentive (e.g., an offer to pay at twice an hourly average rate) comprises an incentive to increase the number of drivers that are driving in advance of an expected increase in demand. In the example shown, in order to take part in the incentive, a driver is required to opt in (e.g., indicate to the driver system that the driver wants to take part). In some embodiments, driver responses are tracked to determine an incentive yield. In some embodiments, driver incentives are adjusted as driver responses are received (e.g., in the event fewer than expected drivers are responding, invite more drivers).

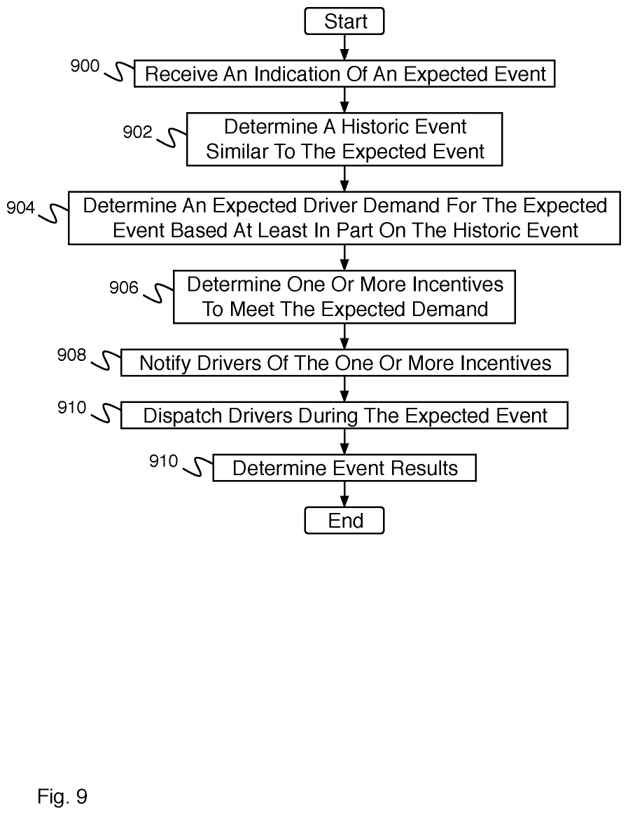

FIG. 9 is a flow diagram illustrating an embodiment of a process for driver supply control. In some embodiments, the process of FIG. 9 is executed by a driver dispatch system (e.g., driver dispatch server system 200 of FIG. 2). In the example shown, in 900, an indication of an expected event is received. In some embodiments, an indication of an expected event is received from an expected event determiner. In various embodiments, an indication of an expected event comprises an expected event type, an expected event time, an expected event location, an expected event size, or any other expected event information. In 902, a historic event similar to the expected event is determined. In some embodiments, a historic event most similar to the expected event is determined. In some embodiments, a plurality of historic events similar to the expected event are determined and combined. In 904, an expected driver demand is determined for the expected event based at least in part on the historic event. In 906, one or more incentives are determined to meet the expected demand. For example, a model of incentive effectiveness is used to determine the type and amount of incentives to offer to which potential drivers. In 908, drivers are notified of the one or more incentive. In 910, drivers are dispatched during the expected event. In various embodiments, driver demand and/or driver supply is tracked. In 910, event results are determined.

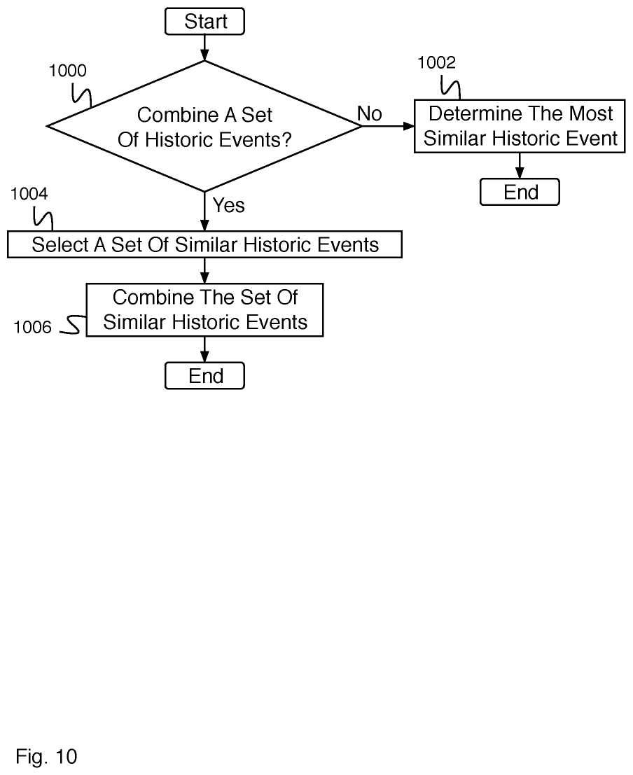

FIG. 10 is a flow diagram illustrating an embodiment of a process for determining a historic event similar to the expected event. In some embodiments, the process of FIG. 10 implements 902 of FIG. 9. In the example shown, in 1000, it is determined whether to combine a set of historic events. In various embodiments, it is determined whether to combine a set of historic events based at least in part on an expected event type, on a number of historic events, on a number of similar historic events, or on any other appropriate information. In the event it is determined to combine a set of historic events, control passes to 1004. In the event it is determined not to combine a set of historic events, control passes to 1002. In 1002, the most similar historic event is selected. In some embodiments, the most similar historic event comprises the historic event of the expected event type that matches the other event data most similarly. The process then ends. In 1004, a set of similar historic events is selected. In some embodiments, the set of similar historic events comprises the set of similar historic events of the same event type as the expected event, the set of similar historic events of the same event type and day of the week as the expected event, the set of similar historic events that are within a predetermined similarity threshold of the expected event, or any other appropriate set of similar historic events. In 1006, the set of similar historic events is combined. In some embodiments, combining the set of similar historic events comprises averaging historic event data.

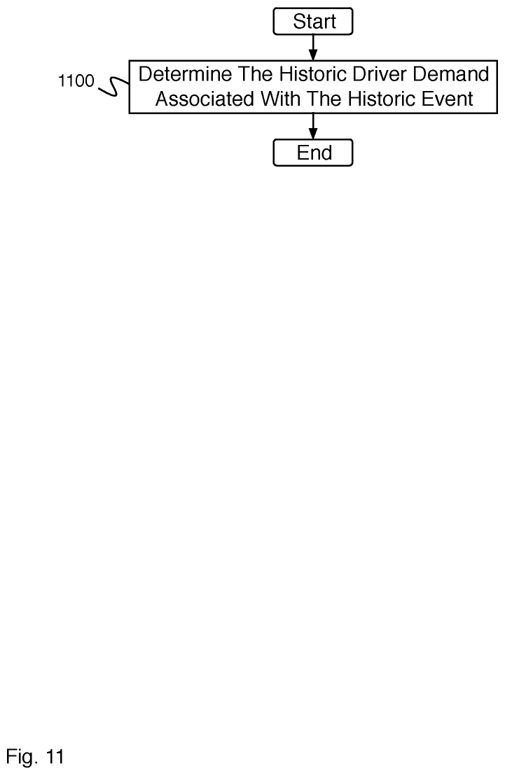

FIG. 11 is a flow diagram illustrating an embodiment of a process for determining an expected driver demand for the expected event based at least in part on the historic event. In some embodiments, the process of FIG. 11 implements 904 of FIG. 9. In 1100, the historic driver demand associated with the historic event is determined. In various embodiments, determining the historic driver demand associated with the historic event comprises determining a stored historic driver demand, determining a stored historic driver demand associated with a given time, determining a stored historic driver demand associated with a given location, or determining any other appropriate historic driver demand.

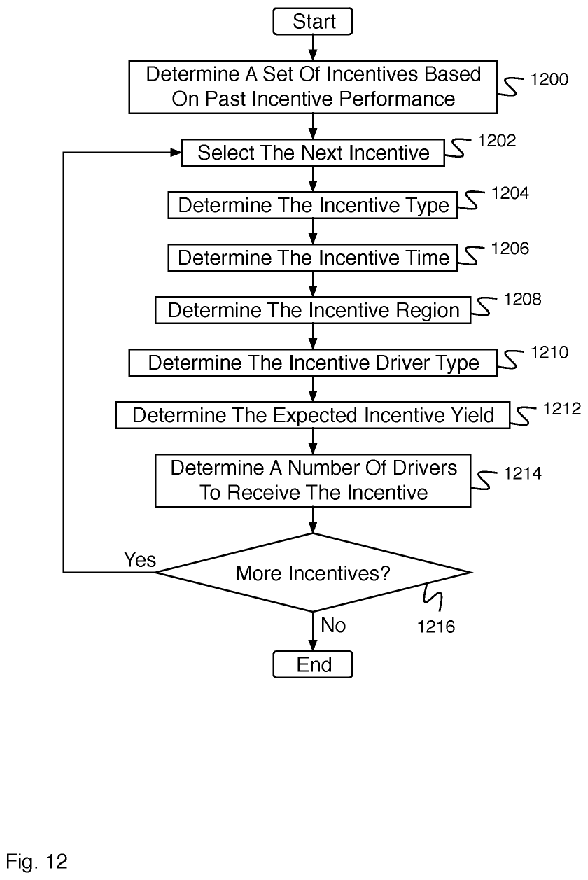

FIG. 12 is a flow diagram illustrating an embodiment for a process for determining one or more incentives to meet expected demand. In some embodiments, the process of FIG. 12 implements 906 of FIG. 9. In the example shown, in 1200, a set of incentives is determined based on past performance. In some embodiments, determining a set of incentives comprises determining a number of incentives. In some embodiments, more than one incentive is used concurrently in the event it is desired to attract a large number of drivers. In 1202, the next incentive is selected. In some embodiments, the next incentive comprises the first incentive. In 1204, the incentive type is determined. In various embodiments, an incentive type comprises a driving rate incentive type, a guaranteed minimum incentive type, a guaranteed number of rides incentive type, or any other appropriate incentive type. In 1206, the incentive time is determined. In some embodiments, the incentive time is based at least in part on an expected event time. In some embodiments, the incentive time is based at least in part on a historical event time. In some embodiments, determining the incentive time comprises determining the time to provide the incentive (e.g., the incentive is active from 4 PM-7 PM and is provided to drivers at 3 PM). In 1208, the incentive region is determined. In some embodiments, the incentive time is based at least in part on an expected event region. In some embodiments, the incentive time is based at least in part on a historical event region. In 1210, the incentive driver type is determined. In various embodiments, the incentive driver type comprises all drivers, highly rated drivers, drivers that additionally drive for another ride sharing service, drivers that usually drive during the determined incentive time, drivers in an indicated geographic region, or any other appropriate driver type. In 1212, an expected incentive yield is determined. In some embodiments, an expected incentive yield comprises an expected fraction of drivers that will respond positively to the incentive. In some embodiments, an expected incentive yield comprises a nonlinear incentive yield (e.g., the expected yield fraction depends on the number of drivers that receive the incentive). In some embodiments, an expected incentive yield is determined from an incentive yield database. In 1214, a number of drivers to receive the incentive is determined. In some embodiments, the number of drivers is determined based at least in part on an expected demand and an expected incentive yield. In 1216, it is determined whether there are more incentives (e.g., more incentives in the set determined in 1200). In the event it is determined that there are more incentives, control passes to 1202. In the event it is determined that there are not more incentives, the process ends.

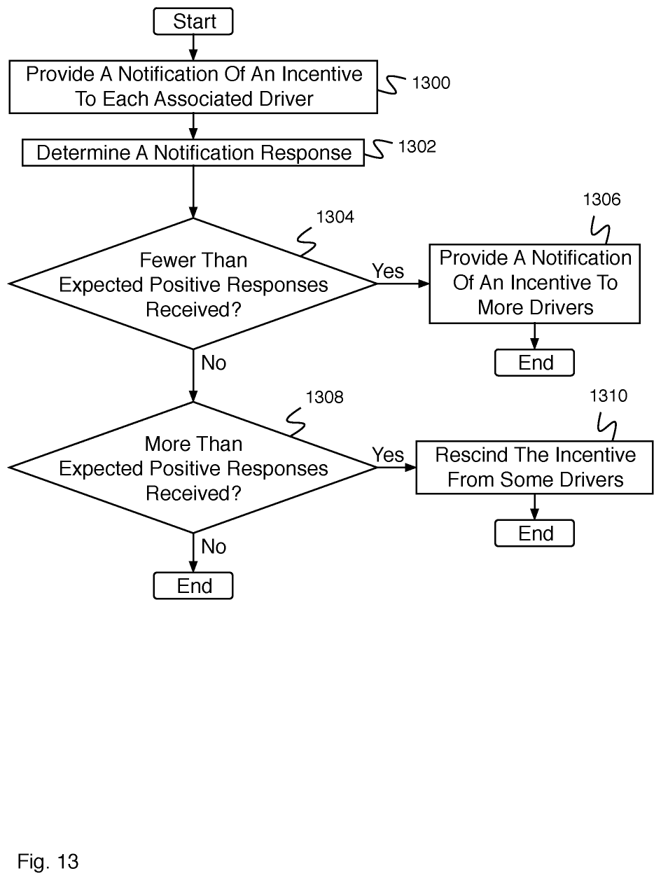

FIG. 13 is a flow diagram illustrating an embodiment of a process for notifying drivers of the one or more incentives. In some embodiments, the process of FIG. 13 implements 910 of FIG. 9. In the example shown, in 1300, a notification of an incentive is provided to each associated driver. In 1302, a notification response is determined. In various embodiments, a notification response comprises an opt in, an opt out, an indication to start driving, inaction, or any other appropriate response. In some embodiments, determining a notification response comprises determining a number of drivers that have opted in, a number of drivers that have opted out, a number of drivers that have started driving, or any other appropriate driver incentive statistic. In 1304, it is determined whether fewer than expected positive responses are received. In some embodiments, positive responses comprise opt ins. In some embodiments, positive responses comprise indications to start driving. In the event it is determined that fewer than expected positive responses were received, control passes to 1306. In 1306, a notification of an incentive is provided to more drivers, and the process ends. In the event it is determined in 1304 that fewer than expected positive responses are not received, control passes to 1308. In 1308, it is determined whether more than expected positive responses are received. In the event it is determined that more than expected positive responses are received, control passes to 1310. In 1310, the incentive is rescinded from some drivers. In some embodiments, the incentive is only rescinded from drivers that have not yet responded positively. The process then ends. In the event it is determined in 1308 that more than expected positive responses have not been received, the process ends.

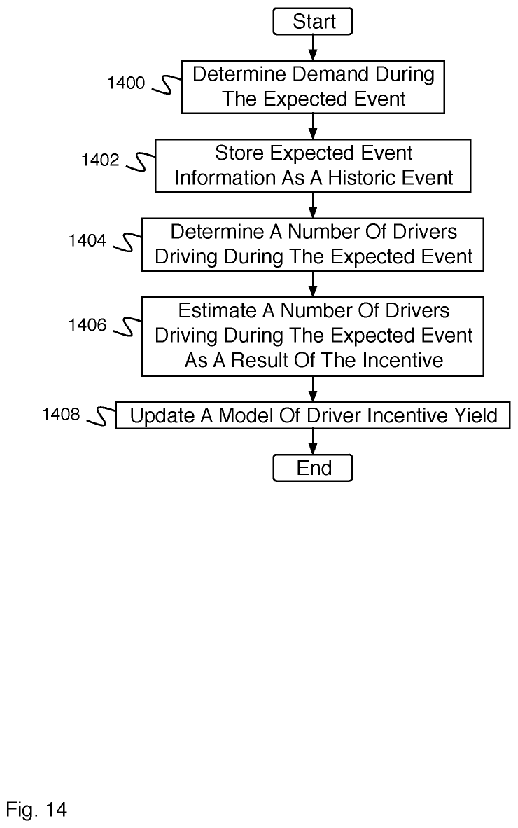

FIG. 14 is a flow diagram illustrating an embodiment of a process for determining event results. In some embodiments, the process of FIG. 14 implements 910 of FIG. 9. In the example shown, in 1400, demand during the expected event is determined. In some embodiments, determining demand comprises determining a number of rides requested during the expected event. In 1402, the expected event information is stored as a historic event (e.g., for use in determining demand for future expected events). In 1404, a number of drivers driving during the expected event is determined. In 1406, a number of drivers driving during the expected event as a result of the incentive is estimated. In some embodiments, a number of drivers driving during the expected event as a result of the incentive is estimated by the difference between the determined number of drivers driving and a typical number of drivers driving. In some embodiments, a number of drivers driving during the expected event as a result of the incentive is estimated based at least in part on the number of drivers opting in to the incentive. In 1408, a model of driver incentive yield is updated.

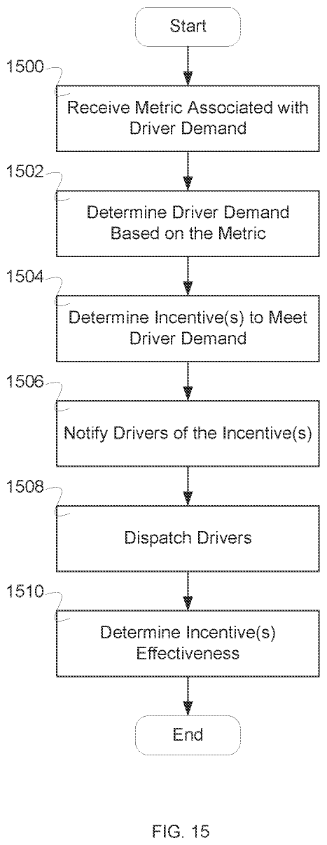

FIG. 15 is a flow diagram illustrating an embodiment of a process for driver supply control. In some embodiments, the process of FIG. 15 is executed by a driver dispatch system (e.g., driver dispatch server system 200 of FIG. 2). In the example shown, in 1500, a metric associated with driver demand is received. For example, a metric is received (e.g., driver estimated time of arrival (ETA)). In various embodiments, the metric comprises one or more of the following: a driver ETA, percentage drivers not driving a passenger, percentage of drivers driving, location of requests and destinations (e.g., in the event that everyone is getting dropped off in one area for morning commute, will not need more supply in that area, but other areas may need more supply), probability and amount of precipitation, number of scheduled rides and their location (e.g., the scheduled rides are an indicator of demand), amount of traffic (e.g., this metric impacts ETAs, trip times, and this turnover rate of drivers), demand/supply estimates from historical year over year data, or any other appropriate indication of driver demand. In 1502, driver demand is determined based on the metric. For example, a model of driver demand based at least in part on one or more metrics. In 1504, incentive(s) is/are determined to meet the driver demand. For example, a model of incentive effectiveness is used to determine the type and amount of incentives to offer to which potential drivers. In some embodiments, the process of FIG. 12 is used to determine incentive(s). In 1506, drivers are notified of the one or more incentive. In some embodiments, the process of FIG. 13 is used to determine notification(s). In 1508, drivers are dispatched. In various embodiments, driver demand and/or driver supply is tracked. In 1510, incentive(s) effectiveness is determined. In some embodiments, a model is updated of the driver incentive yield.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer-implemented method comprising:
receiving, via an input interface of a driver dispatch server system, an indication of an expected event corresponding to a target region;
analyzing a historical event database to select a plurality of similar historical events that satisfy a similarity threshold relative to the expected event;
combining historical event data from the historical event database for the plurality of similar historical events to generate an expected number of requests from requestor mobile devices for driver mobile devices corresponding to the expected event;
selecting, based on the expected number of requests from requestor mobile devices for driver mobile devices corresponding to the expected event and an incentive yield data model, a number of digital incentive notifications;
transmitting, via an output interface of the driver dispatch server system for display via user interfaces of a plurality of provider mobile computing devices, the number of digital incentive notifications;
based on monitoring user interactions with the number of digital incentive notifications via the plurality of provider mobile computing devices, modifying the number of digital incentive notifications transmitted by the driver dispatch server system;
monitoring, via the input interface of the driver dispatch server system, a number of driver mobile computing devices during the expected event to determine a driver yield; and
updating the incentive yield data model based on the number of driver mobile computing devices during the expected event reflected in the driver yield.

2. The computer-implemented method of claim 1, wherein selecting the plurality of similar historical events comprises:
determining similarity metrics by comparing at least one of event type, event size, or event time between the historical events and the expected event to determine similarity metric; and
applying the similarity threshold to the similarity metrics to select the plurality of similar historical events.

3. The computer-implemented method of claim 1, wherein combining the historical event data comprises averaging the historical event data across the plurality of similar historical events to determine the expected number of requests from requestor mobile devices for driver mobile devices corresponding to the expected event.

4. The computer-implemented method of claim 1, further comprising generating the incentive yield model utilizing a nonlinear incentive yield function and historical yield data.

5. The computer-implemented method of claim 1, wherein transmitting the number of digital incentive notifications comprises:
selecting an incentive transmission time based on at least one of the target region or historical event times; and
transmitting the number of digital incentive notifications according to the incentive transmission time.

6. The computer-implemented method of claim 1m wherein transmitting the number of digital incentive notifications comprises selecting the plurality of provider mobile computing devices based on historical driving patterns corresponding to the incentive transmission time.

7. The computer-implemented method of claim 1, wherein modifying the number of digital incentive notifications comprises:
determining a number of responding provider mobile computing devices of the plurality of provider mobile computing devices based on the user interactions with the plurality of digital incentive notifications; and
rescinding one or more digital incentive notifications from one or more of the plurality of provider mobile computing devices based on the number of responding provider mobile computing devices.

8. The computer-implemented method of claim 1, wherein modifying the number of digital incentive notifications comprises transmitting an additional set of digital incentive notifications to an additional set of provider mobile computing devices based a number of responding provider mobile computing devices of the plurality of provider mobile computing devices.

9. A system comprising:
at least one processor; and
a non-transitory computer readable storage medium comprising instructions that, when executed by the at least one processor, cause the system to:
receive, via an input interface of the system, an indication of an expected event corresponding to a target region;
analyze a historical event database to select a plurality of similar historical events that satisfy a similarity threshold relative to the expected event;
combine historical event data from the historical event database for the plurality of similar historical events to generate an expected number of requests from requestor mobile devices for driver mobile devices corresponding to the expected event;
select, based on the expected number of requests from requestor mobile devices for driver mobile devices corresponding to the expected event and an incentive yield data model, a number of digital incentive notifications;
transmit, via an output interface of the system for display via user interfaces of a plurality of provider mobile computing devices, the number of digital incentive notifications;
based on monitoring user interactions with the number of digital incentive notifications via the plurality of provider mobile computing devices, modify the number of digital incentive notifications transmitted by system;
monitor, via the input interface of the system, a number of driver mobile computing devices during the expected event to determine a driver yield; and
update the incentive yield data model based on the number of driver mobile computing devices during the expected event reflected in the driver yield.

10. The system of claim 9, further comprising instructions that, when executed by the at least one processor, cause the system to select the plurality of similar historical events by:
determining similarity metrics by comparing at least one of event type, event size, or event time between the historical events and the expected event to determine similarity metric; and
applying the similarity threshold to the similarity metrics to select the plurality of similar historical events.

11. The system of claim 9, further comprising instructions that, when executed by the at least one processor, cause the system to combine the historical event data by averaging the historical event data across the plurality of similar historical events to determine the expected number of requests from requestor mobile devices for driver mobile devices corresponding to the expected event.

12. The system of claim 9, further comprising instructions that, when executed by the at least one processor, cause the system to generate the incentive yield model utilizing a nonlinear incentive yield function and historical yield data.

13. The system of claim 9, further comprising instructions that, when executed by the at least one processor, cause the system to transmit the number of digital incentive notifications by:
selecting an incentive transmission time based on at least one of the target region or historical event times; and
transmitting the number of digital incentive notifications according to the incentive transmission time.

14. The system of claim 9, further comprising instructions that, when executed by the at least one processor, cause the system to transmit the number of digital incentive notifications by selecting the plurality of provider mobile computing devices based on historical driving patterns corresponding to the incentive transmission time.

15. The system of claim 9, further comprising instructions that, when executed by the at least one processor, cause the system to modify the number of digital incentive notifications by:
determining a number of responding provider mobile computing devices of the plurality of provider mobile computing devices based on the user interactions with the plurality of digital incentive notifications; and
rescinding one or more digital incentive notifications from one or more of the plurality of provider mobile computing devices based on the number of responding provider mobile computing devices.

16. The system of claim 9, further comprising instructions that, when executed by the at least one processor, cause the system to modify the number of digital incentive notifications comprises transmitting an additional set of digital incentive notifications to an additional set of provider mobile computing devices based a number of responding provider mobile computing devices of the plurality of provider mobile computing devices.

17. A non-transitory computer readable storage medium comprising instructions that, when executed by at least one processor, cause the at least one processor to:
receive, via an input interface of a driver dispatch server system, an indication of an expected event corresponding to a target region;
analyze a historical event database to select a plurality of similar historical events that satisfy a similarity threshold relative to the expected event;
combine historical event data from the historical event database for the plurality of similar historical events to generate an expected number of requests from requestor mobile devices for driver mobile devices corresponding to the expected event;
select, based on the expected number of requests from requestor mobile devices for driver mobile devices corresponding to the expected event and an incentive yield data model, a number of digital incentive notifications;
transmit, via an output interface of the driver dispatch server system for display via user interfaces of a plurality of provider mobile computing devices, the number of digital incentive notifications;
based on monitoring user interactions with the number of digital incentive notifications via the plurality of provider mobile computing devices, modify the number of digital incentive notifications transmitted by the driver dispatch server system;
monitor, via the input interface of the driver dispatch server system, a number of driver mobile computing devices during the expected event to determine a driver yield; and
update the incentive yield data model based on the number of driver mobile computing devices during the expected event reflected in the driver yield.

18. The non-transitory computer readable storage medium of claim 17, further comprising instructions that, when executed by the at least one processor, cause the at least one processor to select the plurality of similar historical events by:
determining similarity metrics by comparing at least one of event type, event size, or event time between the historical events and the expected event to determine similarity metric; and
applying the similarity threshold to the similarity metrics to select the plurality of similar historical events.

19. The non-transitory computer readable storage medium of claim 17, further comprising instructions that, when executed by the at least one processor, cause the at least one processor to generate the incentive yield model utilizing a nonlinear incentive yield function and historical yield data.

20. The non-transitory computer readable storage medium of claim 17, further comprising instructions that, when executed by the at least one processor, cause the at least one processor to transmit the number of digital incentive notifications by:
selecting an incentive transmission time based on at least one of the target region or historical event times; and
transmitting the number of digital incentive notifications according to the incentive transmission time.
